(19) United States
(12) Patent Application Publication
(10) Pub. No.: US 2006/0278084 A1
(43) Pub. Date: Dec. 14, 2006

(54) Dehumidifier

(75) Inventor: Chi Wan Kim, Changwon-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/450,314

(22) Filed: Jun. 12, 2006

(30) Foreign Application Priority Data
Jun. 13, 2005 (KR) P2005-0050280
Jun. 13, 2005 (KR) P2005-0050281

(51) Int. Cl. B01D 53/02; F25D 17/06; F25D 21/00

(52) U.S. Cl. 96/140; 62/94; 62/272; 96/141

(57) ABSTRACT

The present invention relates to a dehumidifier for improving dehumidifying efficiency, and discharging dehumidified water to an outside of the dehumidifier easily. The dehumidifier includes a case, an inlet passed through the case for introduction of air from an outside of the case to an inside of the case, an outlet formed to pass through a top of the case for discharging air dehumidified in the case to the outside of the case, a desiccant assembly for absorbing moisture from air drawn into the case, a blower assembly for drawing air through the inlets and blowing the air to the outlet, a regenerator assembly for blowing hot air to the desiccant assembly for drying the desiccant assembly, a heat exchanger for condensing high temperature, humid air blown by the regenerator assembly through the desiccant assembly, to separate the moisture from the air, a water tank mounted so as to be able to placed in, or taking out of the case, for receiving, and holding water condensed at the heat exchanger, and a water amount display unit for visible indication of a water level of the water tank to an outside of the case.

### TECHNICAL FIELD

The present invention relates to dehumidifiers, and more particularly, to a dehumidifier, in which moisture is adsorbed, not by refrigerant, but by desiccant to collect the moisture separately, for improving dehumidifying efficiency.

### BACKGROUND ART

In general, the dehumidifier reduces humidity of a room by drawing humid air from the room, making the humid air to pass through a heat exchanger having a condenser and an evaporator through which refrigerant flows to remove moisture from the air, and discharging the air having the moisture removed therefrom, again.

That is, the dehumidifier takes heat from air around it by vaporizing liquid refrigerant at the evaporator. In more detail, a temperature of the evaporator drops as the refrigerant vaporizes, and as the air passes through the evaporator, a temperature of the air also drops.

As the temperature around the evaporator drops, the moisture in the air condenses, to form dew on a surface of the evaporator.

FIG. 1 illustrates a diagram of a related art dehumidifier.

Referring to FIG. 1, the related art dehumidifier is provided with a cabinet 1 having an inlet (not shown) for drawing room air, a filter 2 mounted on an inlet side, a heat exchanger 3 in front of the filter 2 on the cabinet 1 for heat exchange with the room air to dehumidify the room air, a fan assembly 4 in front of the heat exchanger 3 for forced circulation of the room air, a water tank 6 under the heat exchanger for collecting condensed water, and a front panel 5, a frontal exterior of the dehumidifier, having an outlet 5a.

However, the related art dehumidifier has the following problems.

The outlet 5a in the front panel 5 provides a poor outer appearance, and is difficult to change a direction of discharge of the air.

Since the water tank 6 is mounted/dismounted through a rear of the cabinet 1, the mounting/dismounting of the water tank 6 is not convenient, and the user can be notice a water level of the water held in the water tank easily.

Because the room air passed through the heat exchanger 3 is discharged to the room again directly even if the moisture is not removed from the air fully, the dehumidifying efficiency is poor.

Moreover, the use of the compressor in the related art humidifier for circulation of the refrigerant leads a production cost high, and causes much noise and vibration during operation.

### DISCLOSURE

### Technical Problem

Accordingly, the present invention is directed to a dehumidifier that substantially obviates one or more problems due to limitations and disadvantages of the related art.

An object of the present invention is to provide a dehumidifier which has a high dehumidifying efficiency, low cost, and very low noise and vibration.

Another object of the present invention is to provide a dehumidifier which has a good looking exterior, and enables easy notice of the water level of the water held in the water tank.

### Technical Solution

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, the dehumidifier includes a case, an inlet passed through the case for introduction of air from an outside of the case to an inside of the case, an outlet formed to pass through a top of the case for discharging air dehumidified in the case to the outside of the case, a desiccant assembly for absorbing moisture from air drawn into the case, a blower assembly for drawing air through the inlets and blowing the air to the outlet, a regenerator assembly for blowing hot air to the desiccant assembly for drying the desiccant assembly, a heat exchanger for condensing high temperature, humid air blown by the regenerator assembly through the desiccant assembly, to separate the moisture from the air, a water tank mounted so as to be able to placed in, or taking out of the case, for receiving, and holding water condensed at the heat exchanger, and a water amount display unit for visible indication of a water level of the water tank to an outside of the case.

### Advantageous Effects

Thus, the dehumidifier of the present invention has the following advantages.

The absorption of moisture from room air and continuous dry of the absorbed moisture by a separate regenerator assembly improves dehumidifying efficiency compared to the related art dehumidifier.

The elimination of a compressor from the related art dehumidifier permits to reduce weight of the dehumidifier, as well as noise of the dehumidifier, to improve convenience of use of the dehumidifier.

Along with this, the water level of the water tank in the case made visible from an outside of the dehumidifier improves convenience of use, and the light from the water amount display unit, serving as an illumination, improves sense of beauty of the dehumidifier.

### DESCRIPTION OF DRAWINGS

The accompanying drawings, which are included to provide a further understanding of the invention, illustrate embodiment(s) of the invention and together with the description serve to explain the principle of the invention. In the drawings;

FIG. 1 illustrates an exploded perspective view of a related art dehumidifier;

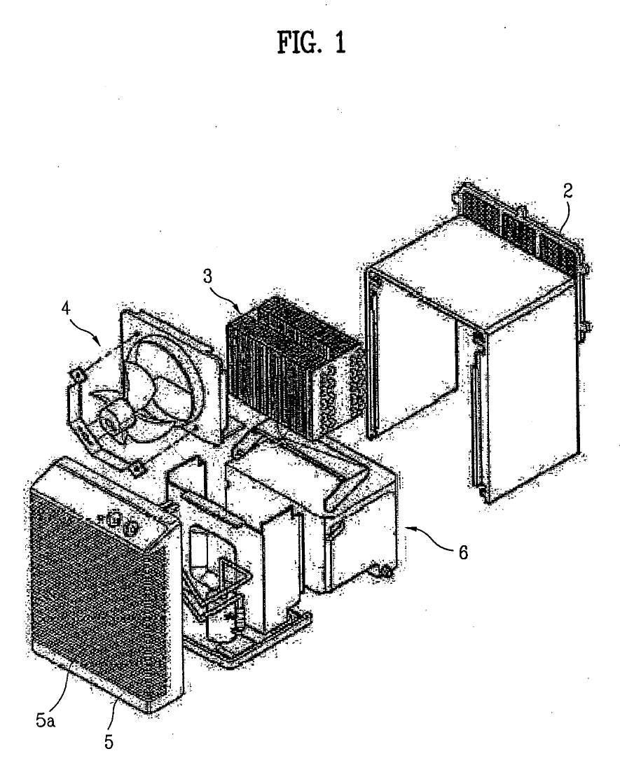

FIG. 2 illustrates a perspective view of a dehumidifier in accordance with a preferred embodiment of the present invention;

FIG. 3 illustrates a perspective view of the dehumidifier in FIG. 2 seen in another direction;

FIG. 4 illustrates a perspective view of the dehumidifier in FIG. 2 having a water tank separated therefrom;

FIG. 5 illustrates an exploded perspective view of the dehumidifier in FIG. 2;

FIG. 6 illustrates an exploded perspective view of the dehumidifier in FIG. 2 for explaining a dehumidifying process;

FIG. 7 illustrates a perspective view of a dehumidifier in accordance with another preferred embodiment of the present invention;

FIG. 8 illustrates a perspective view of the dehumidifier in FIG. 7 seen from a rear thereof;

FIG. 9 illustrates the dehumidifier in FIG. 7 having a water tank separated therefrom;

FIG. 10 illustrates an exploded perspective view of the dehumidifier in FIG. 7;

FIG. 11 illustrates a perspective view of a dehumidifier in accordance with another preferred embodiment of the present invention;

FIG. 12 illustrates the dehumidifier in FIG. 11 having a water tank separated therefrom;

FIG. 13 illustrates an exploded perspective view of the dehumidifier in FIG. 11 having a rear panel thereof opened; and

FIG. 14 illustrates an exploded perspective view of the dehumidifier in FIG. 11.

### BEST MODE

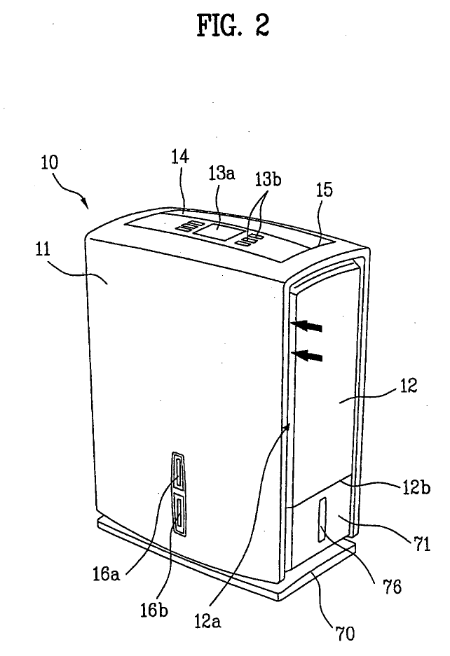

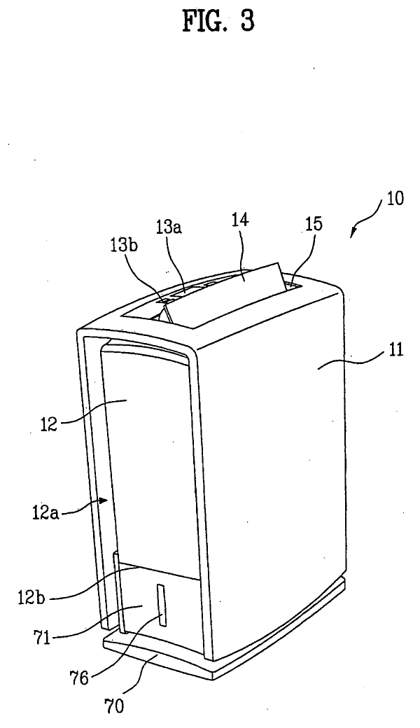

Reference will now be made in detail to the preferred embodiments of the present invention, examples of which are illustrated in the accompanying drawings FIGS. 2 to 6. Wherever possible, the same reference numbers will be used throughout the drawings to refer to the same or like parts.

Referring to FIGS. 2 to 5, the dehumidifier includes a case 10 of an exterior of the dehumidifier, a heat exchanger 20 of a heat conductive material in the case 10, a desiccant assembly 30 in the case 10 for absorbing moisture from the air, a blower assembly 40 for forcing the room air to be drawn into the case 10, and a regenerator assembly 50 for forced circulation of a portion of the room air drawn into the case 10 through the heat exchanger 20.

The case 10 includes a case body 11 of a front, a rear, and a top sides of the dehumidifier, two side panels 12 coupled to opposite sides of the case body 11 to form sides of the case body 11, and a base pan 70 of a bottom of the case 10.

The case body 11 has substantially an inverted U shaped profile with opened opposite sides and lower side. The side panel 12 has a rectangular plate shape, substantially. There is a gap between one side edge of the side panel 12 and one side edge of the case body 11. The gap forms an inlet 12a for drawing room air into the case body 11.

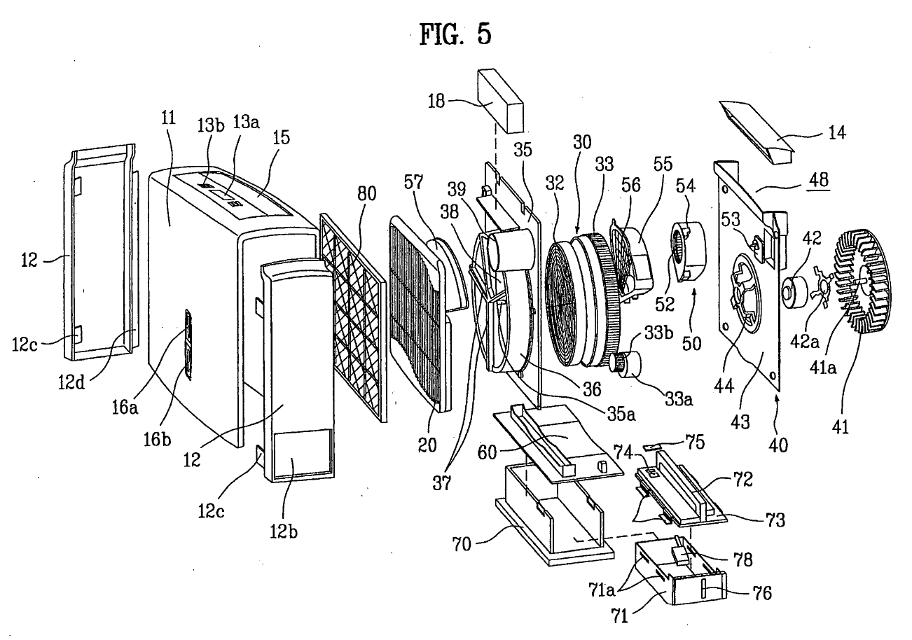

The side panel 12 has fastening portions 12c and 12d (see FIG. 5) of hook shapes extended backward from opposite side edges by predetermined lengths, respectively. The fastening portions 12c and 12d are held by fastening grooves (not shown) in the case body 11 formed in correspondence to the fastening portions 12c and 12d. Of the fastening portions 12c and 12d of the side panel 12, the fastening portion 12c at the one side edge that forms the inlet 12a is spaced from a bottom and a top of the side panel 12, and the fastening portion 12d formed at the other side edge of the side panel 12 is formed as one body from the top to the bottom. Thus, the fastening portion at one side edge of the side panel 12 is divided for smooth introduction of air through the inlet 12a.

The side panel 12 has a top side bent inwardly. Therefore, when the side panels 12 are coupled to opposite sides of the case body 11, there are predetermined spaces formed between top sides of the side panels 12 and the opposite top sides of the case body 11, through which the user may insert fingers to move of the dehumidifier.

At a lower side of one of the side panels 12, there is a water tank opening 12b for mounting/dismounting a water tank 71 for holding water dehumidified at the dehumidifier.

The case body 11 has a display unit 13a substantially at a center of the top for displaying an operation state of the dehumidifier. The display unit 13a is transparent and has substantially a rectangular shape for displaying a present temperature of the room and functional icons for indicating operating states.

On opposite sides of the display unit 13a, there are a plurality of buttons 13b for operating the dehumidifier. On a rear side of the display unit 13b, there is an outlet 15 for discharging air dehumidified in the case body 11.

Accordingly, the dehumidifier of the present invention has a structure in which room air is drawn through sides of the case 10, dehumidified in the case 10, and discharged upward from the case 10.

The outlet 15 is formed in a rectangular shape on a rear side of the top of the case body 11. On an inner side of the outlet 15, there is a discharge louver 14 for opening/closing the outlet 15, and controlling a discharge direction of the air. Though not shown, the discharge louver 14 is mounted to rotate in an up/down direction by driving means around a shaft at opposite sides thereof in the outlet 15.

Accordingly, when the dehumidifier is not in operation, the discharge louver 14 rotates downward to close the outlet 15, and when the dehumidifier in operation, the discharge louver 14 rotates upward to open the outlet 15, and controls the discharge direction of the air.

In the meantime, the case body 11 has a full water display window 16a at middle of a lower half of the front of the case body 11 for displaying a full water state of the water tank 71.

The full water display window 16a is constructed of a transparent tube of plastic for easy notice from an outside of the dehumidifier, and has a light emitting means (not shown) therein for indicating the full water state of the water tank 71 with a color or flashing.

That is, the light emitting means are LEDs (Light Emitting Diodes) of particular colors, for an example, a blue color and red color, connected to a water level sensing float (see FIG. 5) in the water tank 71, so that the blue LED emits a light when the water is not full in the water tank 71, and the red LED emits a light when the water is full in the water tank 71 to indicate full of the water tank 71.

Besides the full water display window 16a, the dehumidifier of the present invention may further include announcing means (not shown) for informing the full water of the water tank 71 with sound or image to an outside of the dehumidifier.

Under the full water display window 16a, there is a water amount indicating window 16b for indicating a water amount in the water tank 71. Alike the full water display window 16a, the water amount indicating window 16b is constructed of a transparent or semi-transparent tube or plastic, with scale marks dividing the tube equally, and has light emitting means (not shown) therein for lighting according to a water amount held in the water tank 71, to indicate the water amount.

In more detail, positions of the water amount in the water tank 71 is divided into three equally, so that a signal from a sensor (not shown) is transmitted to a controller 18 (see FIG. 5) of the dehumidifier if a float 78 in the water tank 71 touches the sensor at one of the positions, for the controller 18 to make the LED of a designated color to emit a color (blue, yellow, or red) of the position, to indicate the present water amount.

In the meantime, referring to FIG. 5, in front of the case 10, there is a filter 80 for cleaning air drawn through the inlet 12a.

The filter 80, for filtering foreign matters from the air, may include a single unit selected from a prefilter for filtering relatively large sized dust from the air drawn through the inlets 11a, and 12a, deodoring filters for removing smell, dust collecting filters each for collecting dust by an electrical action, and a HEPA filter for removing fine dust, or an assembly having above various filters combined as one unit.

On a front side of the inside of the case 10, there is a heat exchanger 20 for making heat exchange with the room air drawn through the inlet 12a. The heat exchanger 20 has two tiers of different sized heat exchangers having a plurality of metal tubes arranged at regular intervals in communication with one another for letting the air blown by the regenerator assembly 50 to be introduced thereto, flow therein, and be discharged therefrom. The heat exchanger 20 has a drain hole (not shown) at a bottom for discharging condensed water from the heat exchanger 20.

In rear of the heat exchanger 20, there is a regenerating cover 57 in correspondence to the heater case 55 to be described later. The regenerating cover 57 has an air pass opening (not shown) in a lower surface in communication with an inside of the heat exchanger 20 for guiding the air circulated by the regenerator assembly 50 to the heat exchanger 20.

In rear of the regenerating cover 57, there is a desiccant assembly 30 for absorbing moisture from the room air drawn through the inlet 12a. The desiccant assembly 30 includes a desiccant member 32 for absorbing moisture from air, a rotor 33 rotatably mounted for housing the desiccant member 32, a rotor housing 35 for supporting the rotor 33 to rotate, and a motor 33a for providing rotating power to rotate the rotor 33.

The desiccant member 32 has a disk shape constructed of paper, with a plurality of pass through holes like a honeycomb. In more detail, the desiccant member 32 is fabricated by rolling two layers of paper like a honeycomb and bonded together, to form a plurality of the pass through holes, and permeating a desiccant solution therein.

According to this, when the room air passes through the pass through holes in the desiccant member 32, the moisture is absorbed in the desiccant member, to dry the air.

The desiccant member 32 has a disk shape and mounted to the rotor 33. The rotor 33 is a circular frame, and has a gear on an outside circumference. On an outer side of the rotor 33, there is a rotor driving gear 33b rotated by the rotor motor 33a. The rotor driving gear 33b is engaged with the outside circumference of the rotor 33, to rotate the rotor 33.

The rotor motor 33a rotates the rotor 33 slowly (for an example, 1 RPM) so that the desiccant member 32 absorbs moisture from the air passing therethrough.

The rotor 33 is housed in, and supported on the rotor housing 35. The rotor housing 35 has a square plate shape substantially, with an opened center. Around the opened center of the rotor housing 35, the rotor cover 36 is formed as a circular rim projected therefrom. In the rotor cover 36, the rotor 33 is housed.

At a center of the rotor cover 36, there is a rotation shaft 35a which is a rotation center of the rotor 33 supported by a plurality of supporting arms 37 extended from an edge of the rotor cover 36 to the center in a radial direction.

At an upper side of a right side of the rotor housing 35, there is a circulating duct 39 for guiding the air from the heat exchanger 20 to the regenerator assembly 50, and at a lower side of the right side of the rotor housing 35, there is the motor 33a coupled with the rotor driving gear 33b as one unit for providing rotating power to rotate the rotor 33.

In rear of the desiccant assembly 30, as a component of the regenerator assembly 50 to be described later, there is a heater 56 for providing heat to dry the desiccant member 32. The heater 56 has a fan shape substantially, and is encased in a heater case 55 having a front and a portion of a top opened.

Accordingly, since the heater case 55 is mounted matched to a fan shaped regenerative flow passage 38 partitioned at an upper side of the rotor housing 35 by the rotor arms 37, the heater case 55 serves to regenerate a portion of the desiccant member 32 to dry the portion, continuously.

In rear of the heater 56, there is the blower assembly 40 for drawing the room air through the inlet 12a, forcibly. The blower assembly 40 includes a fan 41 for drawing the room air through the inlet 12a, a blower housing 43 for housing, and supporting the fan 41, and a fan motor 42 for providing rotation power to the fan 41.

The blower housing 43 has a square plate shape substantially, with a circular opening at a center, to form a flow passage of the room air drawn by the rotation power of the fan 41. At a top of the blower housing 43, there is a discharge flow passage 48 for discharging the room air drawn by the fan 41 to an outside of the dehumidifier.

At the opened portion of the blower housing 43, there is a motor support 44 for housing a portion of the fan motor 42, and supporting the fan motor 42. Opposite to the motor support 44, there is a motor mount 42a for securing the fan motor 42.

In front of an upper side of the blower assembly 40, there is the regenerator assembly 50 for passing a portion of the room air drawn through the inlet 12a through the case 10.

The regenerator assembly 50 includes a regenerating fan 52, a regenerating fan housing 54 for housing and supporting the regenerating fan 52, a regenerating motor 53 for providing a rotating power to rotate the regenerating fan 52, a heater 56 for providing heat to dry the desiccant member 32, and a heater case 55 for casing the heater 56. The regenerating fan 52 may be a centrifugal type fan, such as a sirocco fan, but a variety of types of fans may be used.

The regenerating fan housing 54 has a disk shape substantially for mounting the regenerating fan 52 therein. The regenerating fan housing 54 has a suction opening at a center in communication with the circulating duct 39, and an outlet at one side of underside in communication with the heater case 55.

Therefore, when the regenerating fan 52 rotates, the air is drawn forcibly into the regenerating fan housing 54 through the circulating duct 39, and discharged to the heater case 55.

That is, the regenerating fan housing 54 guides the air from the regenerating fan 52 to the heater 56 and the regenerating flow passage 38, to keep drying a portion of the desiccant member 32 rotating at a position opposite thereto.

In the meantime, there is a drain pan 60 under the heat exchanger 20 for collecting condensed water from the heat exchanger 20 and guiding to a water tank 71. The drain pan 60 is rectangular substantially, with a drain groove projected upward for guiding condensed water from the heat exchanger 20 to the water tank 71.

Under the drain pan 60, there is a base pan 70 forming a bottom of the case 10 for fixedly coupling the front frame 11 and the rear frame 12. The base pan 70 has a hexahedral box shape with opened one side opposite to the side panel 12.

The water tank 71 has a hexahedral box shape having an opened top. On top of the water tank 71, there is a water tank cover 73 detachably mounted thereon for opening/closing the opened top of the water tank 71. On opposite sides of the water tank cover 73, there are a plurality of water tank cover fasteners 77 for hooking with fastening projections 71a at upper sides of opposite sides of the water tank 71, respectively.

It is preferable that there is a water tank handle 76 at a center of a top of the water tank cover 73 for easy handling of the water tank 71. On one side of the water tank handle 76, there is a water tank inlet 74 in communication with a bottom of the drain groove 61 for guiding the water to the water tank 71.

On the water tank inlet 71, there is an inlet cover 75 for preventing water from flowing out of the water tank 71 at the time the water tank 71 in in/out.

In the water tank 71, there is a float 78 (not shown) for moving up/down along with a water level, and is connected to a sensor (not shown) to sense the water level.

It is preferable that there is a water level noticing transparent window 76 at one side of the water tank 71, i.e., one side exposed to an outside of the side panel 12, for noticing the water level held in the water tank 71 with naked eyes. Accordingly, besides the full water display window 16a and the water amount indicating window 16b, the user can determine the water level of the water tank 71 by means of the water level noticing transparent window 76.

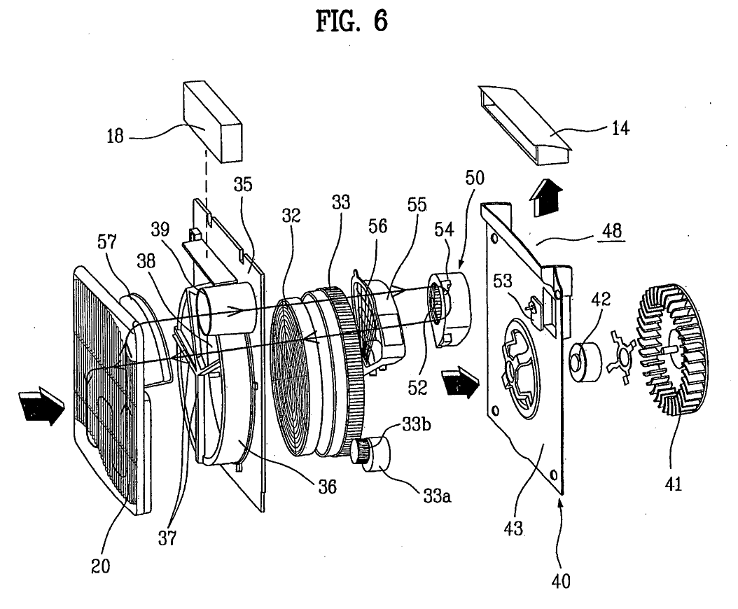

The operation of the dehumidifier of the present invention will be described in detail with reference to FIG. 6.

As indicated with large arrows, when humid room air is drawn into the case 10 through the inlet 12a (see FIG. 2) by the rotating power of the fan 41, the air has foreign matters removed therefrom as the air passes through the filter 80 (see FIG. 5), and passes through the desiccant assembly 30 via the heat exchanger 20.

In this instance, the air has moisture removed therefrom as the air passes through the pass through holes in the desiccant member 32, and is discharged to the discharge flow passage 48 through the fan 41 of the blower assembly 40. Then, the air discharged to the discharge flow passage 48 is discharged to the room through the discharge louver 14.

Next, as indicated with small arrows, in a regenerating process for drying the desiccant member 32 of the desiccant assembly 30 continuously, the air blown forcibly by the rotation of the regenerating fan 52 passes through the heater 60 through the heater case 55, and is heated to warm air such that the warm air evaporates moisture absorbed in the desiccant member 32.

The high temperature, humid air passed through the desiccant member 32 moves toward the heat exchanger 20 through the regenerating flow passage 38, and introduced into the regenerating cover 57. Then, the high temperature, humid air circulates through an inside of the heat exchanger 20, and has moisture therein condensed as the high temperature, humid air heat exchanges with the room air having a relatively low temperature drawn through the inlets l a, and 12a in the circulating process. The condensed water is drained to the drain groove 61 of the drain pan 60 through the drain hole (not shown) at the bottom of the heat exchanger, and held in the water tank 71.

In the meantime, the air passed through the heat exchanger 20 and having moisture therein removed therefrom repeats circulation in which the air is guided to the regenerating flow passage 38 through the rotor housing 35 and the circulating duct 39 again by the regenerating fan 52, to repeat the regenerating process of drying the desiccant member 32, continuously.

Thus, the dehumidifier of the present invention removes moisture from the room air by means of two streams of air flow. That is, the room air drawn by the fan 41 passes through, and has moisture therein absorbed at, the desiccant member 32, and is discharged to an outside of the dehumidifier through the outlet 15.

At the same time with this, while the dehumidifier makes the high temperature air to flow through the regenerative flow passage 38 by the regenerating fan 52, the dehumidifier separates the moisture from a portion of the desiccant member again and blows toward the heat exchanger 20, to condense, and remove the moisture from the air, at the heat exchanger 20, and circulates the air by the regenerating fan 52.

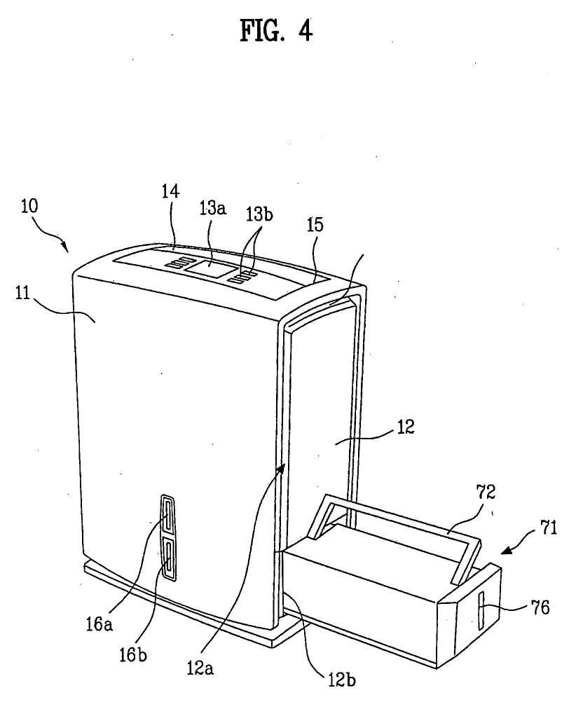

As the float 78 floats up following rise of the water level of the water tank 71 through the dehumidifying process, the LED of a color corresponding to the water level is lighted on the water amount indicating window 16b. If the water tank 71 is full with water for the float (not shown) to sense the full water level, a color of the full water displaying window 16a changes to inform that the water tank 71 is full to an outside of the dehumidifier. Then, as shown in FIG. 4, the user may pull out the water tank 71 through the water tank opening 12b, empty the water tank 71, and place the empty water tank 71 in the case 10, again.

In above embodiment of the dehumidifier, the float 78 is provided to the water tank 71 for floating on the water, to determined the water level as the float 78 is brought into contact with the sensor. However, different from this, a water level sensor having electrodes with different lengths may be provided, for sensing the water level as the water is brought into contact with the different electrodes of the water level senor.

Of course, besides this, the water level may be sensed by using one of a variety of known water level sensing unit.

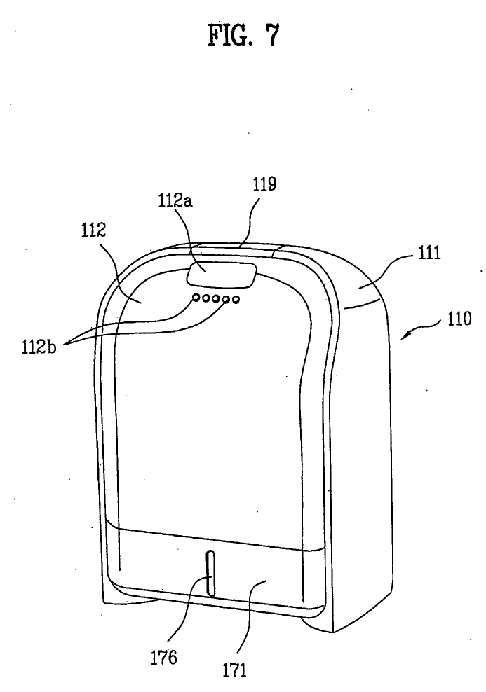

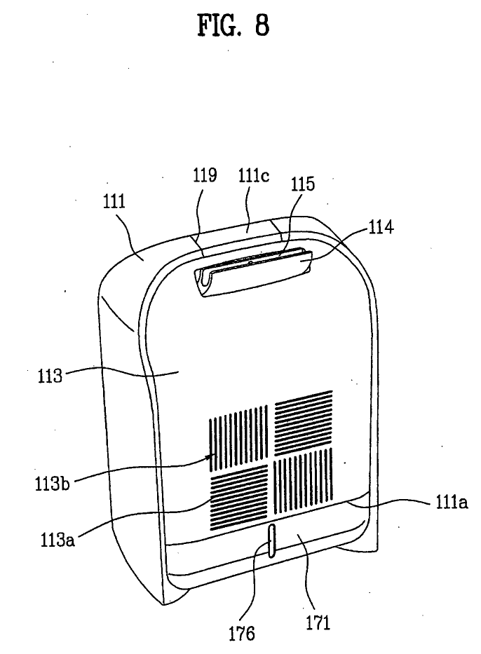

Next, a dehumidifier in accordance with another preferred embodiment of the present invention will be described with reference to FIGS. 7 to 10. Parts identical to the parts of the foregoing embodiment will be given the same reference numerals, and detailed description of which will be omitted.

The dehumidifier of the embodiment includes a case 110, a heat exchanger 20, a desiccant assembly 30, a blower assembly 40, and a regenerator assembly 50. The heat exchanger 20, the desiccant assembly 30, the blower assembly 40, and the regenerator assembly 50 are identical to the foregoing embodiment, of which detailed description will be omitted.

The case 110 includes a case body 111 of an inverted U shape having opened front and rear, a front panel 112 on a front of the case body 111, and a rear panel 113 to close a rear of the case body 111.

The front panel 112 and the rear panel 113 are rectangular plate shapes substantially each having a top side curved inwardly. Therefore, once the front panel 112 and the rear panel 113 are coupled to the case body 111, the dehumidifier becomes to have curved exterior at front and rear top, to provide a more graceful exterior than a case the top is flat.

The front panel 112 and the rear panel 113 has heights lower than the opened front and rear of the case body 111. Therefore, formed at lower sides of the front panel 112 and the rear panel 113, there is a space for placing in and taking out the water tank 71.

On a top of the front panel 112, there is a display unit 112a for displaying an operation state of the dehumidifier. Under the display unit 112a, there are operation buttons 112b for the user to operate the dehumidifier.

On a top of the case body 111, there is a dehumidifier handle 119 for the user to hold the dehumidifier with a hand and move the dehumidifier. The dehumidifier handle is placed in a dehumidifier handle groove 11c in the top of the case body 111. It is preferable that the dehumidifier handle 119 is of one touch type in which the dehumidifier handle 119 is moved up/down with a spring and touch means (not shown) by one time of pressing.

In the meantime, there is a suction grill 113b at a substantially center of the rear panel 113 for guiding room air to an inside of the dehumidifier. The suction grill 113b is a combination of a plurality of groups of vertical or horizontal slots 113a. The embodiment includes vertical slot 113a groups, and horizontal slot 113a groups arranged, diagonally.

At a top side of the rear panel 113, there is an outlet 115 for guiding the air dehumidified in the dehumidifier to be discharged to the room again. Accordingly, the dehumidifier has a rear side suction, and a top side discharge structure in which room air is drawn through the center of the rear panel 113, and the air dehumidified thus is discharged to the top side of the rear panel 113.

To the outlet 115, there is a discharge louver 114 for controlling a discharge direction of air. Though not shown, the discharge louver 114 is mounted such that the discharge louver 114 rotates in up/down direction around a shaft (not shown) at opposite sides of the outlet 15 by driving means.

Accordingly, when the dehumidifier is not in operation, the discharge louver 114 is rotated downward, to close the outlet 115, and when the dehumidifier is in operation, the discharge louver 114 is rotated upward, to open the outlet 115 and control the discharge direction of the air dehumidified thus.

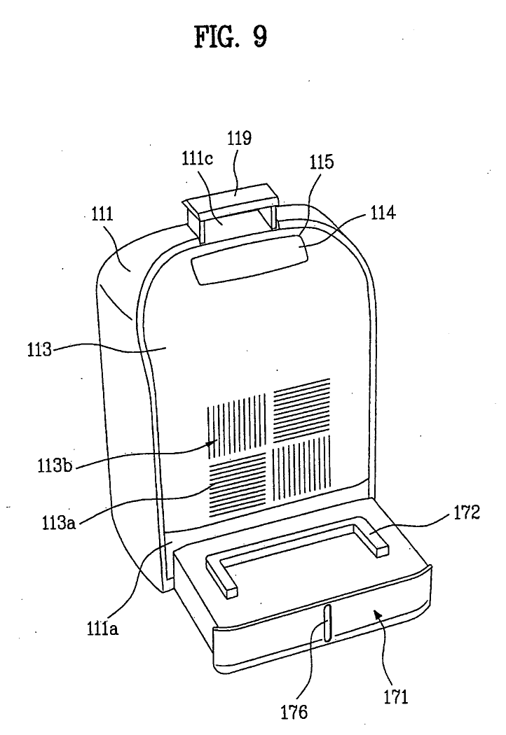

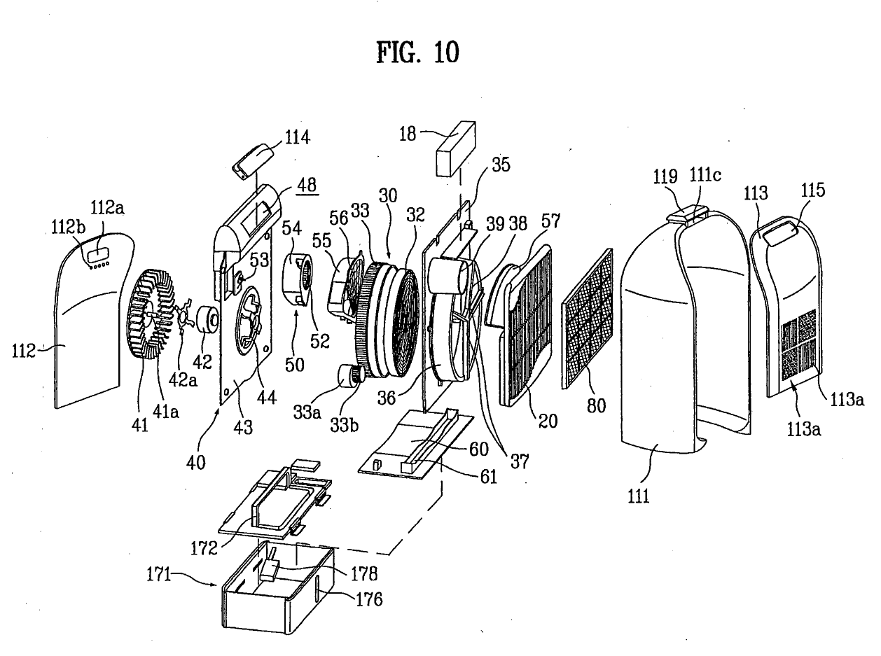

Referring to FIGS. 9 and 10, on a lower side of the case 110, a water tank 171 for holding dehumidified water is mounted to be slideable in front/read direction in mounting/dismounting the water tank 171.

On a front and a rear of the water tank 171, there are transparent water level noticing windows 176 for easy notice of an amount of the water held in the water tank 171 from an outside of the dehumidifier. Accordingly, the user can make easy notice of the water level in the water tank 171 through the transparent water level noticing window 176 and take a proper measure.

In the water tank 171, there is a float 178 for moving up/down along with a water level, and is connected to a sensor (not shown) to inform the present state of the water level of the water tank 171 to an outside of the dehumidifier through the display unit 112a if the water level in the water tank reaches to a predetermined level.

Since a process for dehumidifying by the dehumidifier is identical to the foregoing embodiment substantially, detailed description of which will be omitted.

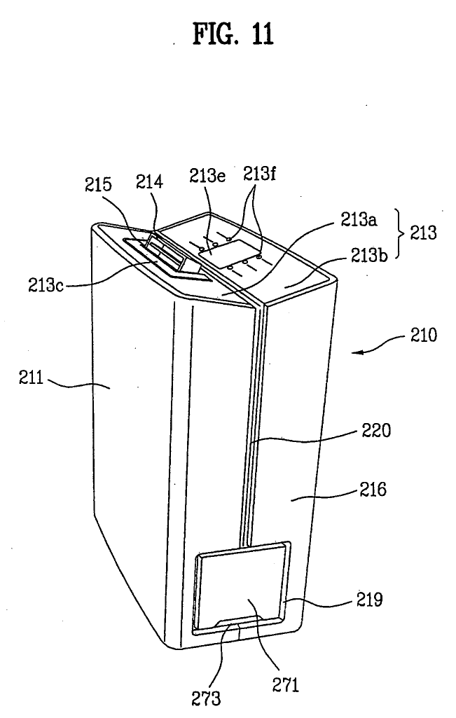

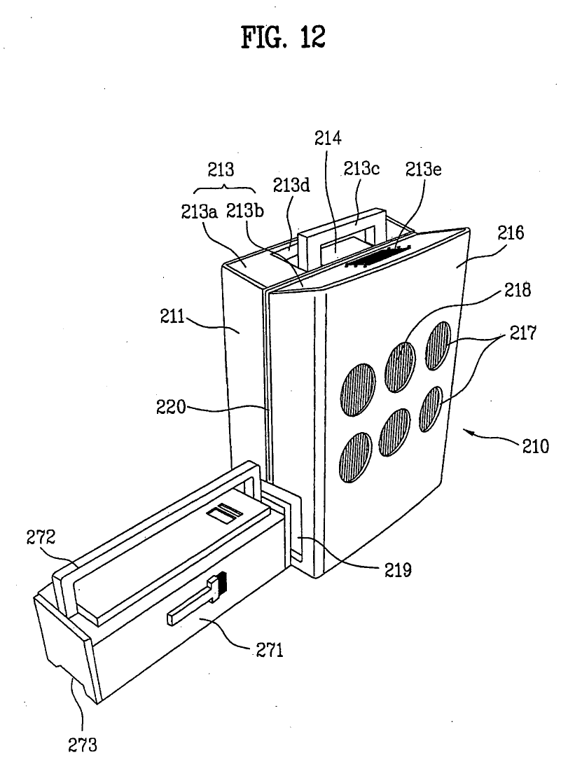

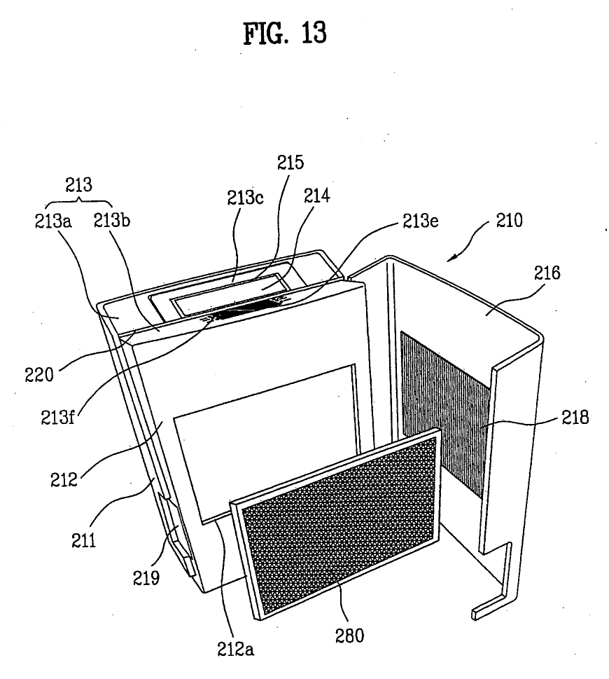

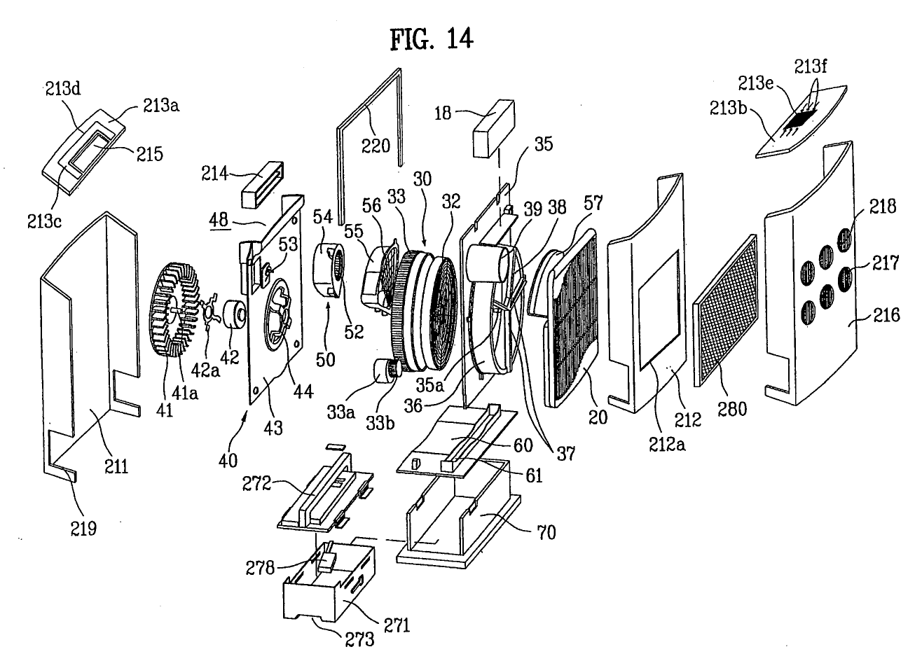

Another preferred embodiment of the present invention will be described with reference to FIGS. 11 to 14.

Except a portion of the case 210, the dehumidifier of the embodiment has units provided in the case 210 for dehumidifying, i.e., the heat exchanger 20, the desiccant assembly 30, the blower assembly 40, and the regenerator assembly 50, identical to the foregoing embodiment.

The dehumidifier of the embodiment has a case 210 having a substantially hexahedral box shape, separable in a front half and a rear half. That is, the case 210 includes a front frame 211 of exteriors of a front and sides of a front half of a hexahedral box, a rear frame 212 of exteriors of a rear and sides of a rear half of a hexahedral box, and a top panel 213 of a top exterior having a front top panel 213a and a rear top panel 213b. At a lower side of the case 210, there is a base pan 70 of the bottom of the case 210.

The front frame 211 has a hexahedral shape with opened rear and top and bottom, and the rear frame 212 has a hexahedral shape with opened front and top and bottom.

Top sides of the front frame 211 and the rear frame 212 are sloped down in a rear direction and a front direction, respectively. Therefore, if the front top panel 213a and the rear top panel 213b are coupled to tops of the front frame 211 and the rear frame 212, the front top panel 213a and the rear top panel 213b are sloped down toward a center. That is, the dehumidifier has a V shaped top side substantially when seen from a side of the case 210.

The front top panel 213a had an outlet 215 for discharging air from the case 210 dehumidified therein. The outlet 215 has a discharge louver 214 rotatably mounted thereon.

The discharge louver 214 has a plurality of louvers fabricated as one unit, with opposite ends hinged (not shown) at opposite sides of the front frame 211, to enable the discharge louver 214 rotatable in a front/rear direction. Though the discharge louver 214 may be designed to rotate by separate driving means, the discharge louver 214 may be designed to have a heavier lower side than a top side with reference to the hinge so that the discharge louver 214 rotates in the front/rear direction by an air pressure being discharging through the outlet 215.

Accordingly, when the dehumidifier is not in operation, the discharge louver 214 rotates in a rear direction, to close the outlet 215, and when the dehumidifier is in operation, the discharge louver 214 rotates in a front direction by the pressure of air being discharged, to open the outlet 215, thereby controlling a direction of the dehumidified air discharged through the outlet 215.

The front top panel 213a has a dehumidifier handle 213c for easy movement of the dehumidifier, and a dehumidifier handle groove 213d for placing the dehumidifier handle 213c therein. The dehumidifier handle 213d has opposite ends hinged to the front top panel 213a to enable to rotate in an up/down direction.

The rear panel 213b has a transparent display unit 213e mounted thereon for displaying an operation state of the dehumidifier. There are a plurality of operation buttons 213f on left/right sides of the display unit 213e for operating the dehumidifier.

The rear frame 212 has an opening 212a of a predetermined size at a center. The opening 212a is a passage of external air being drawn into the case 210.

Mounted in rear of the rear frame 212, there is a rear panel 216. The rear panel 216 has a shape substantially similar to the rear frame 212, and is rotatably hinged to one side edge of the rear frame 212.

Accordingly, the rear panel 216 not only improves an outer appearance of the dehumidifier, but also enables rotation in a lateral direction, to make replacement of the filter 280 easy.

At a center of the rear panel 216, there are a plurality of circular holes 217 for guiding suction of room air. Mounted on an inside of the rear panel 216, there is a suction grill 218 for making an inside invisible from an outside of the dehumidifier while permitting air flow. Therefore, if a suction force is generated at an inside of the dehumidifier, the room air is drawn into the case 210 through the circular holes 217 and the suction grill 218, for dehumidifying.

As described before, the filter 280 is detachably mounted to the opening 212a of the rear frame 212.

At lower sides of one sides of the front frame 211 and the rear frame 212, there is a water tank opening 219 for mounting/dismounting the water tank 271 therethrough.

The water tank 271 has a handle 272 rotatably mounted thereon. At one side of the water tank 271, i.e., at a lower side of a portion of the water tank 219 exposed to an outside of the dehumidifier, there is a hand grip for the user to put finger there in and pull the water tank 271.

Therefore, when it is intended to draw the water tank 271 out of the case 210, if the user puts in fingers in the hand grip 273 and pulls the dehumidifier, the water tank 271 is drawn easily while the water tank 271 slides in a lateral direction.

Provided between the front frame 211 and the rear frame 212, there is a water amount display unit 220 for displaying a water amount of the water tank 271. The water amount display unit 220 has an inverted U shape substantially. The water amount display unit 220 is constructed of a transparent tube or plastic, and has light emitting means (not shown) of at least one color mounted therein for emitting a color of light according to a water amount sensed by a float (not shown) in the water tank 271.

For an example, light emitting means (for an example LEDs) of yellow, blue, and red colors may be mounted in the water amount display unit 220, to turn on yellow light emitting means when water starts to flow into the water tank 271 initially, to turn on blue light emitting means when water reaches to a middle of the water level, and to turn on red light emitting means when water reaches to a full water level, to inform the user to empty the water tank.

Of course, other than this, there can be a variety of variations. For an example, different from above, light emitting means of only one color may be mounted to the water amount display unit 220, to turn on the light emitting means only when the water reaches to the full water level only.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A dehumidifier comprising:
a case;
an inlet passed through the case for introduction of air from an outside of the case to an inside of the case;
an outlet formed to pass through a top of the case for discharging air dehumidified in the case to the outside of the case;
a desiccant assembly for absorbing moisture from air drawn into the case;
a blower assembly for drawing air through the inlets and blowing the air to the outlet;
a regenerator assembly for blowing hot air to the desiccant assembly for drying the desiccant assembly;
a heat exchanger for condensing high temperature, humid air blown by the regenerator assembly through the desiccant assembly, to separate the moisture from the air;
a water tank mounted so as to be able to placed in, or taking out of the case, for receiving, and holding water condensed at the heat exchanger; and
a water amount display unit for visible indication of a water level of the water tank to an outside of the case.

2. The dehumidifier as claimed in claim 1, wherein the water amount display unit includes;
a water level sensing unit in the water tank for sensing an amount of water held in the water tank, and
a transparent or semi-transparent water amount display portion having light emitting means of at least one color for emitting a light according to the water amount measured at the water level sensing unit.

3. The dehumidifier as claimed in claim 2, wherein the water amount display portion further includes light emitting means of different colors for turning on according to water levels of the water tank, respectively.

4. The dehumidifier as claimed in claim 2, wherein the water amount display portion includes;
a full water level display portion for emitting a light when the water in the water tank reaches to a full water level, and
a low water level display portion for emitting a light before the water in the water tank reaches to the full water level.

5. The dehumidifier as claimed in claim 2, wherein the water amount display portion has a tube shape attached to the case.

6. The dehumidifier as claimed in claim 2, wherein the water amount display portion is mounted on a front of the case.

7. The dehumidifier as claimed in claim 2, wherein the water level sensing unit includes;
a float mounted to be floated by water held in the water tank, and a sensor for sensing a water level as the float is floated so as to be in touch therewith.

8. The dehumidifier as claimed in claim 1, wherein the water amount display unit is a transparent window extended in an up/down direction on a surface of the water tank exposed to an outside of the case.

9. The dehumidifier as claimed in claim 1, wherein the desiccant assembly includes;
a desiccant member for absorbing moisture from air,
a desiccant rotor rotatably mounted for housing the desiccant member,
a desiccant rotor housing for rotatably supporting the desiccant rotor, and
a rotating unit for rotating the desiccant rotor.

10. The dehumidifier as claimed in claim 9, wherein the rotating unit includes;
a gear formed along an outside circumference of the desiccant rotor,
a rotor driving gear engaged with the gear, and
a rotor motor for providing a rotating power to rotate the rotor driving gear.

11. The dehumidifier as claimed in claim 1, wherein the blower assembly includes;
a fan for generating a suction power for drawing air,
a blower housing for housing and supporting the fan, and
a fan motor mounted on the blower housing for rotating the fan.

12. The dehumidifier as claimed in claim 1, wherein the regenerator assembly includes;
a regenerating fan for blowing air toward the desiccant assembly,
a regenerating fan housing for housing the regenerating fan,
a regenerating motor for providing a rotating power to rotate the regenerating fan,
a heater for heating the air blown by the regenerating fan,
a heater case for casing the heater, having one side in communication with the regenerating fan housing, and the other side in communication with a portion of the desiccant assembly for guiding air from the regenerating fan to the desiccant assembly,
a regenerating cover for guiding the air passed through the desiccant assembly by the regenerating fan to an inside of the heat exchanger, and
a circulating duct for guiding the air passed through the heat exchanger to the regenerating fan.
